(19) United States
(12) Patent Application Publication
(10) Pub. No.: US 2007/0121270 A1
(43) Pub. Date: May 31, 2007

(54) CLAMPING APPARATUS FOR OPTICAL MEMBERS

(75) Inventor: YANG-CHANG CHIEN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,614

(22) Filed: Aug. 31, 2006

(30) Foreign Application Priority Data
Nov. 25, 2005 (CN) 200510101775.9

(51) Int. Cl. H05F 3/00

(52) U.S. Cl. 361/220

(57) ABSTRACT

An exemplary clamping apparatus (9) for optical members (40) includes a holder (10) and a protecting member (20). The holder has a plurality of receiving members (12) therein for receiving the optical members. The protecting member covers the optical members and carries a static electrical charge.

### 1. FIELD OF THE INVENTION

The present invention generally relates to clamping apparatuses and, more particularly, to a clamping apparatus configured (i.e., structured and arranged) for receiving optical members such as optical lenses, optical filters, or such like.

### 2. DESCRIPTION OF RELATED ART

With the ongoing development of micro-circuitry and multimedia technologies, digital cameras have become a highly popular way of taking pictures. High-end portable electronic devices, such as mobile phones and personal digital assistants (PDAs), are being developed to include increasing numbers of special features. Many of these portable electronic devices are now equipped with a digital camera module, these electronic devices enable consumers to enjoy capturing digital pictures anytime and anywhere, the smallest and most eye-catching cameras being the most popular.

In camera modules, optical lenses are very important to the quality of the pictures captured by the camera modules. Many optical lenses are made of plastic. In the manufacturing process after injection molding the optical lenses, they are received in a clamping apparatus before plating a film thereon. However, optical elements are easily become charged with static electricity. The optical elements are prone to attract dust from the air due to the static electricity. As a result, a surface of each optical element may easily become polluted.

Therefore, a new clamping apparatus is desired in order to overcome the above-described shortcomings.

### SUMMARY OF THE INVENTION

In one embodiment thereof, a clamping apparatus for optical members includes a holder and a protecting member. The holder has a plurality of receiving members therein for receiving the optical members. The protecting member covers the optical members and carries a static electrical charge.

Other advantages and novel features of the embodiments will become more apparent from the following detailed description thereof when taken in conjunction with the accompanying drawings.

### BRIEF DESCRIPTION OF THE DRAWINGS

Many aspects of the present clamping apparatus can be better understood with reference to the following drawings. The components in the drawings are not necessarily drawn to scale, the emphasis instead being placed upon clearly illustrating the principles of the clamping apparatus and its potential applications. Moreover, in the drawings, like reference numerals designate corresponding parts throughout the several views.

FIG. 1 is an isometric view of a holder with optical members of a clamping apparatus in accordance with a preferred embodiment of the present invention;

FIG. 2 is an assembled, isometric view of the clamping apparatus with optical members; and

FIG. 3 is a cut-away view of the clamping apparatus with optical members along line III-III in FIG. 2.

### DETAILED DESCRIPTION OF THE EMBODIMENTS

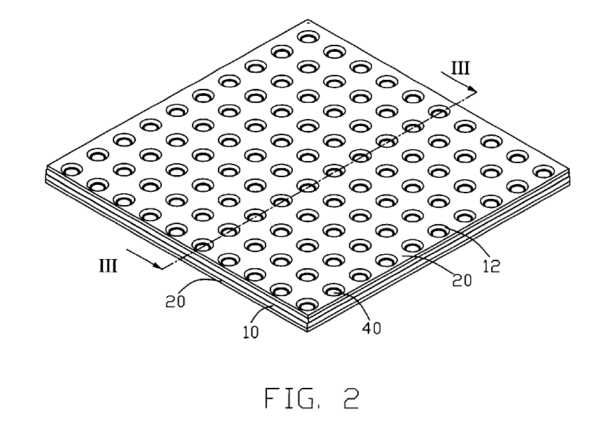

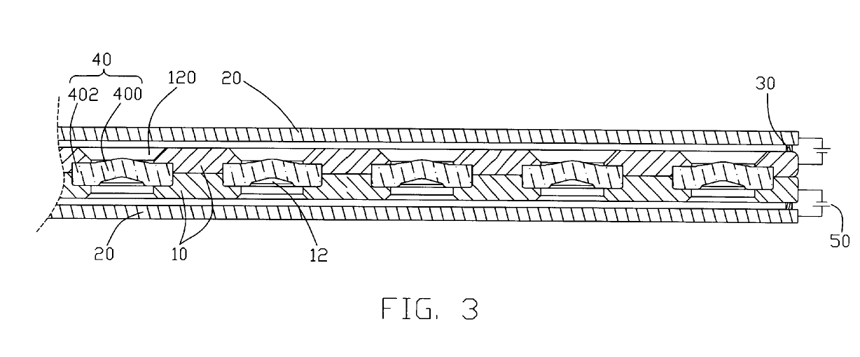

Referring now to the drawings in detail, FIGS. 2-3 show a clamping apparatus with optical members 40 of a preferred embodiment of the present invention. The clamping apparatus includes two holders 10, two protecting members 20, a plurality of spacers 30, and two electrostatic sources 50. The spacers 30 are placed between the holder 10 and the protecting member 20. The electrostatic source 50 is electrically connected with the holder 10 and the protecting member 20. The clamping apparatus is capable of receiving a plurality of optical members 40 at a time.

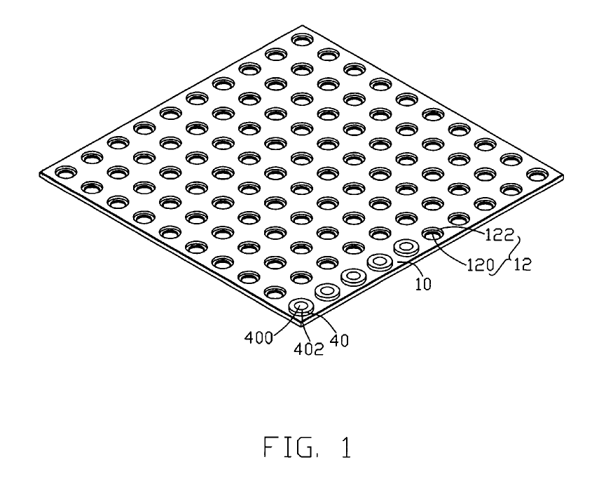

Also referring to FIG. 1, the optical members 40 may be optical lenses, optical filters, or such like. In this embodiment, each optical member 40 has a positioning portion 402 and an optical portion 400. The optical portion 400 is provided in a center of the positioning portion 402. The optical portion 400 is configured for allowing light to pass through. The positioning portion 402 is configured for mounting the optical member 40 to the clamping apparatus.

Each holder 10 is a substantially square board in shape and is preferably made of metal. A plurality of receiving members 12 is arrayed in the holder 10 for receiving the optical members 40. The receiving member 12 includes a light-passing hole 120 and a positioning hole 122. The light-passing hole 120 is defined in one surface of the holder 10. The positioning hole 122 is defined in the other opposing surface of the holder 10. The light-passing hole 120 and the positioning hole 122 communicate with each other and are coaxially arranged. A diameter of the light-passing hole 120 is smaller than a diameter of the positioning hole 122. The diameter of the positioning hole 122 is engaged with a diameter of the positioning portion 402 of the optical member 40 thereby allowing the positioning hole 122 to receive the positioning portion 402. The diameter of the light-passing hole 120 is matched with a diameter of the optical portion 400 of the optical member 40 in a manner such that all light from the light-passing hole 120 can completely pass through the optical portion 400.

Further referring to FIG. 3, each protecting member 20 is a film or a thin board. The protecting member 20 is preferably made of polyvinyl chloride or polyethylene. Each spacer 30 is made of electrically insulating material such as plastic, wood and such like.

In use, a plurality of optical members 40 are disposed in the receiving members 12 of one holder 10. One part of the positioning portion 402 of each optical member 40 is received in the positioning hole 122 of the receiving member 12. The optical portion 400 of each optical member 40 is exposed out from the light-passing hole 120 of the receiving member 12. The other holder 10 is placed on the holder 10 with optical members 40. The other part of the positioning portion 402 is received in the positioning hole 122 of the other holder 10. Thus the optical members 40 are held by the two holders 10. The plurality of spacers 30 is placed on a periphery of each surface having the light-passing hole 120 of the holders 10. The protecting member 20 is placed on the spacers 30 thereby covering each surface having the light-passing hole 120 of the holders 10. An anode of each electrostatic source 50 is electrically connected to one protecting member 20. A cathode of each electrostatic source 50 is electrically connected to one holder 10. Thus each protecting member 20 is electrified with negative electrical charge thereby attracting dust from the air.

It is to be understood that the light-passing hole 120 may be conical in shape. One holder 10 may be omitted. That is to say there is only one holder 10 to receive the optical members 40. The protecting member 20 may be electrified with tribo-electricity by friction. The spacers 30 may be omitted and the protecting members 20 can be directly provided on the holders 10.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A clamping apparatus for optical members, comprising:
a holder having a plurality of receiving members therein for receiving the optical members; and
a protecting member configured for covering the optical members and carrying a static electrical charger.

2. The clamping apparatus as claimed in claim 1, wherein the receiving members are arrayed in the holder.

3. The clamping apparatus as claimed in claim 1, wherein the receiving member includes a light-passing hole and a positioning hole, the light-passing hole is defined in one surface of the holder, the positioning hole is defined in the other opposing surface of the holder, and the light-passing hole and the positioning hole communicate with each other.

4. The clamping apparatus as claimed in claim 3, wherein the light-passing hole and the positioning hole are coaxially arranged.

5. The clamping apparatus as claimed in claim 1, further comprising a plurality of spacers positioned between the holder and the protecting member.

6. The clamping apparatus as claimed in claim 5, wherein the spacers are made of insulating material.

7. The clamping apparatus as claimed in claim 1, further comprising another holder, wherein the two holders cooperate to receive the optical members.

8. The clamping apparatus as claimed in claim 7, wherein the two holders have same configuration.

9. The clamping apparatus as claimed in claim 1, further comprising an electrostatic source electrically connecting the holder and the protecting member.

10. The clamping apparatus as claimed in claim 9, wherein an anode of the electrostatic source is electrically connected to the protecting member and a cathode of the electrostatic source is electrically connected to the holder.

11. The clamping apparatus as claimed in claim 1, wherein the protecting member is electrified with tribo-electricity by friction.

12. The clamping apparatus as claimed in claim 1, wherein the protecting member is made of a material selected from a group consisting of polyvinyl chloride and polyethylene.

13. The clamping apparatus as claimed in claim 1, wherein the protecting member is a film.

14. The clamping apparatus as claimed in claim 1, wherein the protecting member is a thin board.
